(19) United States
(12) Patent Application Publication
(10) Pub. No.: US 2005/0225857 A1
(43) Pub. Date: Oct. 13, 2005

(54) Substrate for protective film for polarizer

(75) Inventor: Masashi Inagaki, Sakata-gun (JP)

Correspondence Address: EDWARDS & ANGELL, LLP, P.O. BOX 55874, BOSTON, MA, 02205, US

(73) Assignee: Mitsubishi Polyester Film Corporation, Tokyo (JP)

(21) Appl. No.: 10/512,801

(22) PCT Filed: Apr. 28, 2003
(86) PCT No.: PCT/JP03/05439

§ 371 Date: Jun. 1, 2005

(30) Foreign Application Priority Data
Apr. 30, 2002 (JP) 2002-127924

(51) Int. Cl. G02B 5/30

(52) U.S. Cl. 359/487

(57) ABSTRACT

A base for polarizing plate protective film, which base is stuck on the surface of a polarizing plate of a liquid crystal display board, comprises a biaxially oriented polyester film having a coating layer on one surface thereof and has such properties that:
the surface resistance of said coating layer is not higher than 1×10¹¹ Ω, the adhesive force (P2) of the acrylic adhesives to the coating layer surface is not more than 3,000 mN/cm, the difference (P1-P2) between the adhesive force (P1) of the rubber adhesives to the coating layer surface and the adhesive force (P2) of the acrylic adhesives is not less than 100 mN/cm, and the film haze is not higher than 2%. Such a polarizing plate protective film base excels in antistatic properties, chemical resistance, scratch resistance, handling quality, transparency, etc.

### TECHNICAL FIELD

The present invention relates to a base for polarizing plate protective film. More particularly, it relates to a base for polarizing plate protective film used for protecting the surface of a polarizing plate of a liquid crystal display board by sticking it to the polarizing plate with an adhesive or such.

### BACKGROUND ART

Usually, a liquid crystal display board is constituted by laminating polarizing plates on both sides of a liquid crystal cell having liquid crystal enveloped between two substrates. And a protective film is stuck on the surface of each polarizing plate in order to prevent scratching or deposition of dust on the polarizing plate surface during circulation of the product or in the process of assemblage of various types of display devices such as computers, word processors and TV. The protective film, after completing its function of protecting the polarizing plate, is separated and removed as useless matter. Usually, separation and removal of the protective film is accomplished by a method in which a rubber type adhesive tape is pressed against the protective film and pulled up.

Hitherto, polyethylene films, ethylene-vinyl acetate copolymer films and the like have been used as the said protective film. These protective films, however, have disadvantages in that they must be once separated before the tests and again stuck on the board after the completion of the tests because the presence of such a protective film may constitute a hindrance to the tests involving the optical evaluations of display performance, hue, contrast, contamination with foreign materials, etc., of the liquid crystal display board.

In Japanese Patent Application Laid-Open (KOKAI) No. 4-30120, as a protective film which need not be separated at the time of the tests involving optical evaluations, there has been proposed a protective film having an optically isotropic adhesive resin layer laminated on an optically isotropic base film. This protective film, however, is still unsatisfactory in respects of chemical resistance, scratch resistance, etc., since a film which has been made by casting and which is almost non-oriented and has a state close to amorphous, is used as base film.

Also, in order to allow detection of more minute defects in a finer picture when conducting the tests involving optical evaluations of display performance, hue, contrast, contamination with foreign matter, et., of a liquid crystal display board with a protective film left stuck on the display board, development of a protective film with higher transparency has been desired.

The present invention has been made in view of the above circumstances, and its object is to provide a base for a high-transparency polarizing plate protective film, which excels in antistatic properties, chemical resistance, scratch resistance, handling quality, transparency, etc., consequently can facilitate the tests for detecting minute defects, and also has specific properties such as capability of preventing adhesion of dusts or adhesives to the liquid crystal display board, and when separated and removed as useless matter after performing its role of protection of the polarizing plate, separation can be effected with ease, and which further has the effects of suppressing separation charging to preclude the possibility of causing damage to the circuits connected to the display board by such separation charging.

### DISCLOSURE OF THE INVENTION

As a result of strenuous studies on the subject matter mentioned above, the present inventors found that, by use of a specific film, the above-said problems can be solved with ease, and the present invention has been attained on the basis of this finding.

Thus, in an aspect of the present invention, there is provided a base for polarizing plate protective film, which base is stuck on the surface of a polarizing plate of a liquid crystal display board, comprises a biaxially oriented polyester film having a coating layer on one surface thereof and has such properties that:
the surface resistance of said coating layer is not higher than 1×10¹¹ Ω,
the adhesive force (P2) of the acrylic adhesives to the coating layer surface is not more than 3,000 mN/cm,
the difference (P1 - P2) between the adhesive force (P1) of the rubber adhesives to the coating layer surface and the adhesive force (P2) of the acrylic adhesives is not less than 100 mN/cm, and
the film haze is not higher than 2%.

Hereinafter, the present invention is described in detail.

The base for polarizing plate protective film according to the present invention, which is designed to be used by sticking it on the surface of a polarizing plate of a liquid crystal display board, comprises a biaxially oriented polyester film having a coating layer on one surface thereof. In a preferred embodiment of the present invention, an adhesive layer is provided on the other side of the polyester film, and a release film is laminated on the surface of the said adhesive layer. The base for polarizing plate protective film according to the present invention is produced generally by passing the steps of forming a coating layer, forming an adhesive layer and laminating a release film successively.

In the present invention, the “biaxially oriented polyester film” is a film obtained by stretching the sheet melt extruded from the extruder head according to the so-called extrusion method.

The “polyester” comprising the film of the present invention designates the polyesters obtained by polycondensing aromatic dicarboxylic acids and aliphatic glycols. As aromatic dicarboxylic acids, terephthalic acid and 2,6-naphthalenedicarboxylic acid can be mentioned, and as aliphatic glycols, ethylene glycol, diethylene glycol and 1,4-cyclohexanedimethanol can be mentioned. Typical examples of the polyesters are polyethylene terephthalate (PET) and polyethylene-2,6-naphthalene dicarboxylate (PEN).

The said polyester may be a copolymer containing a third component. As the dicarboxylic acid moiety of the copolymer polyester, isophthalic acid, phthalic acid, terephthalic acid, 2,6-naphthalenedicarboxylic acid, adipic acid, sebacic acid, and oxycarboxylic acids (such as P-oxybenzoic acid) can be mentioned. As the glycol moiety, ethylene glycol, diethylene glycol, propylene glycol, butanediol, 1,4-cyclohexanedimethanol, and neopentyl glycol can be mentioned. Two or more of these dicarboxylic acids and glycols may be used in combination.

In the present invention, in view of the handling quality of the film, it is preferable to contain the particles in the film under the condition that it does not impair transparency of the film. As such particles, for instance silicon dioxide, calcium carbonate, aluminum oxide, titanium dioxide, kaolin, talc, zeolite, lithium fluoride, barium sulfate, carbon black, and fine particles of heat-resistant polymers such as disclosed in Japanese Patent Publication (KOKOKU) No. 59-5216 can be mentioned. Two or more types of these particles may be used in combination. The average size of these particles is usually 0.02 to 2 μm, preferably 0.05 to 1.5 μm, more preferably 0.05 to 1 μm. The content of the particles in the film is usually 0.01 to 2% by weight, preferably 0.02 to 1% by weight.

Known methods can be used for containing particles in the film. For instance, particles may be added at any stage in the polyester producing process. It is particularly preferable to add particles as a slurry formed by dispersing the particles in ethylene glycol or the like, at the stage of esterification or at a stage after the completion of ester exchange reaction and before the start of polycondenstion reaction, and to proceed the polycondensation reaction. It is also possible to use other methods, for example, a method in which a slurry formed by dispersing particles in ethylene glycol or water and a polyester material are blended by using a vented kneader/extruder, and a method in which the dried particles and a polyester material are blended by using a kneader/extruder.

Production of the film is conducted by a method which comprises melt extruding the material from the extruding head according to a known extrusion method to form a sheet, and stretching and orienting it in the biaxial directions, viz. in the machine and transverse directions.

In the extrusion method, a polyester is melt extruded from the extruding head and cooled and solidified by cooling rolls to obtain a non-stretched sheet. In this case, in order to improve planarity of the sheet, it is necessary to enhance tight attachment of the sheet to the rotary cooling drum, for which an electrostatic pinning method or a liquid coating adhesion method is preferably used.

The method of biaxially stretching and orienting the film is not specifically defined, but a simultaneous biaxial stretching method, successive biaxial stretching method or the like may be used.

In the simultaneous biaxial stretching method, the said non-stretched sheet is stretched and oriented in both machine and transverse directions simultaneously with the temperature being controlled at usually 70 to 120° C., preferably 80 to 110° C. The stretch ratio is usually 4 to 50 times, preferably 7 to 35 times, more preferably 10 to 20 times the original area. Then the sheet is subjected to a heat treatment at 170 to 250° C. under tension or under a relaxation of not more than 30% to obtain a stretched and oriented film.

In the successive biaxial stretching method, the said non-stretched sheet is stretched in one direction by a roll or tenter type stretching machine. The stretching temperature is usually 70 to 120° C., preferably 80 to 110° C., and the stretching ratio is usually 2.5 to 7 times, preferably 3.0 to 6 times. Then, the sheet is further stretched in the direction perpendicular to the initial stretching direction. The stretching temperature is usually 70 to 120° C., preferably 80 to 115° C., and the stretch ratio is usually 3.0 to 7 times, preferably 3.5 to 6 times. Then the sheet is further subjected to a heat treatment at 170 to 250° C. under tension or under a relaxation of not more than 30% to obtain a stretched and oriented film.

For the said stretching, it is possible to use a method in which stretching in one direction is conducted in two or more stages. In this case, it is preferable to carry out the operation so that the stretch ratios in the two directions would finally fall within the above-defined ranges. Also, if necessary, additional stretching in the machine and/or transverse direction may be conducted before or after the heat treatment.

In the present invention, film thickness is not specifically defined, but it is usually in the range of 5 to 150 μm, preferably 10 to 100 μm, more preferably 25 to 75 μm. If film thickness is less than 5 μm, liquid crystal display board surface protective properties of the film may deteriorate, and also the film handling quality in the wear-resistant layer forming step or the adhesive layer forming step tend to get worse. On the other hand, if film thickness exceeds 150 μm, because of a drop of flexibility and a decline of total light transmittance, the film handling and working properties as a protective film may be adversely affected, and also trouble may arise in the tests involving optical evaluations of display performance, hue, contrast, contamination with foreign materials, etc., of the liquid crystal display board.

The coating layer constituting the film of the present invention is formed, for instance, by applying a cationic copolymer in a state of being dissolved or dispersed in a solvent such as water, methyl alcohol, ethyl alcohol, isopropyl alcohol or the like, on one surface of a biaxially oriented polyester film, and drying the coat. The coating operation is not subject to any specific restrictions, and it is usually carried out with a coating machine such as air knife coater, blade coater, bar coater, gravure coater, curtain coater and roll coater. Coating layer thickness is usually in the range of 0.01 to 0.3 μm, preferably 0.05 to 0.2 μm. If coating layer thickness is less than 0.01 μm, the adhesive force of the coating layer with an acrylic adhesive tends to elevate, while if the coating thickness exceeds 0.3 μm, there is formed a visually observable Moiré fringe in the coating layer, which may constitute a hindrance to the tests of the polarizing plate or crystal liquid display board. In the coating, if necessary, other additives such as monomer, resin, crosslinking agent, pigment, etc., may be properly mixed as far as they give no adverse effect on performance of the cationic copolymer used.

As the “cationic copolymers” referred to herein, those comprising cationic monomeric units, hydrophobic monomeric units and organopolysiloxane units as main components can be exemplified.

The cationic monomeric units usable in the present invention are, for instance, those containing a quaternary ammonium base in the units. Particularly use of the monomeric units represented by the following formula (a) can provide more excellent antistatic and antifouling properties: 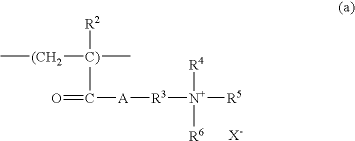
wherein A represents O or NH, R² represents hydrogen or CH₃, R³ represents a C₂-C₄ alkylene group or —CH₂CH(OH)CH₂—, R⁴, R⁵ and R⁶ represent independently a C₁-C₁₀ alkyl or aralkyl group, and X represents a halogen or an alkylsulfate acid ion.

More specifically, the said cationic monomeric units include, for example, (meth)acrylic monomeric units such as (meth)acryloyloxytrimethylammonium chloride, (meth)acryloyloxyhydroxypropyltrimethyl-ammonium chloride, (meth)acryloyloxytriethylammonium chloride, (meth)acryloyloxydimethylbenzylammonium chloride, (meth)acryloyloxytrimethylammonium chloride, and (meth)acryloyloxytrimethylammoiummethyl sulfate, and (meth)acrylamide type cationic monomeric units such as (meth)acrylamidopropyltrimethylammonium chloride, (meth)acrylamidopropyltrimethylammonium chloride, and (meth)acrylamidopropyldimethylbenzylammonium chloride.

In these monomeric units, the corresponding monomers may be polymerized, or first their precursors, viz. the monomers containing a ternary amino group, such as dimethylaminoethyl(meth)acrylate or dimethylaminopropylacrylamide may be polymerized and then cationized with a modifier such as methyl chloride.

The content of the cationic monomeric units in the copolymer is preferably 15 to 60% by weight. If the content of these monomeric units is less than 15% by weight, antistatic properties of the product tends to prove unsatisfactory. If their content exceeds 60% by weight, blocking tends to occur.

The hydrophobic monomeric units usable in the present invention include various types of monomeric materials, for example, alkyl(meth)acrylates such as methyl(meth)acrylate, ethyl(meth)acrylate, butyl(meth)acrylate, isobutyl(meth)acrylate, tertiary-butyl(meth)acrylate, cyclohexyl(meth)acrylate, 2-ethylhexyl(meth)acrylate, lauryl(meth)acrylate, tridecylacrylate and stearyl(meth)acrylate, styrene, and vinyl esters such as vinyl acetate.

The content of the hydrophobic monomeric units in the copolymer is preferably 30 to 84.9% by weight. If their content is less than 30% by weight, antifouling properties of the product tend to become unsatisfactory, and if their content exceeds 84.9% by weight, antistatic performance tends to lower relatively.

The organopolysiloxane units usable in the present invention are preferably those represented by the following formula (b): 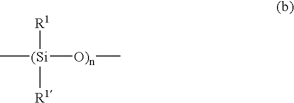
wherein R¹ and R^{1′} represent independently a C₁-C₁₀ alkyl or phenyl group, and n is an integer of 5 or more.

If n in the above formula (b) is less than 5, it may become difficult to afford sufficient lubricity to the. obtained copolymer.

The ratio of the organopolysiloxane units contained in the cationic copolymer is usually 0.1 to 20% by weight. If such a ratio is less than 0.1% by weight, antifouling properties tend to become unsatisfactory. Also, antifouling properties are not bettered additionally even if the above ratio exceeds 20% by weight.

Specifically, the organopolysiloxane units in the cationic copolymer are preferably incorporated in the copolymer by using their precursors represented by the following formula (c), (d) or (e). The precursors represented by the following formulae can be incorporated in the copolymer by using a reactive group D. 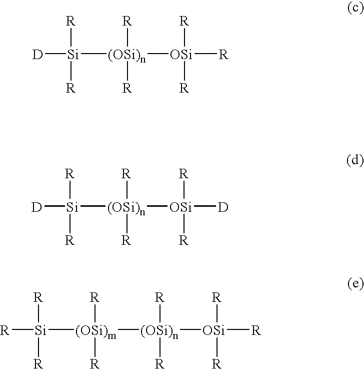
In the above formulae (c) to (e), D represents a radical polymerizable group selected from the group consisting of vinyl groups, acryloyloxyalkyl groups and methacryloyloxyalkyl groups, an epoxy group such as glycidoxyalkyl group, an aminoalkyl group or a mercaptoalkyl group; R represents a C₁-C₁₀ alkyl or phenyl group; m is an integer of 1 to 20; and n is an integer of 5 or more.

As the precursor, it is possible to use those commercially available as reactive silicone, but in view of the fact that reactivity lowers when the molecular weight increases, it is preferable to use ones in which n in their formulae is not more than 200 in case where the precursor is (c) or (d) and not more than 400 even in case where the reactive groups of the formula (e) are present in large number.

As for the method of incorporating these precursors as a cationic copolymer component, in case where the reactive group D is a polymerizable group, the precursor is polymerized simultaneously with other monomers, and in case where D is a mercaptoalkyl group, a cationic monomer (a) and a hydrophobic monomer (b) are polymerized in the presence of the said precursor, whereby the precursor can be introduced efficiently by chain transfer. Further, in case where the reactive group D is an epoxy group, copolymerization of a cationic monomer (a) and a hydrophobic monomer (b) is carried out together with other monomers, for example, hydrochlorides of carboxyl group-containing monomers such as (meth)acrylic acid having reactivity with epoxy groups or tertiary amine group-containing monomers such as dimethylaminoethyl (meth)acrylate, and the resulting product is reacted with the epoxy group of the precursor.

Likewise, in case where the reactive group D is an aminoalkyl group, copolymerization of a cationic monomer (a) and a hydrophobic monomer (b) is carried out together with a monomer reactive with amino groups, such as glycidyl (meth)acrylate, and the resulting product is further reacted with the amino group of the precursor. If necessary, other hydrophilic monomers such as hydroxyethyl (meth)acrylate and vinylpyrrolidone may be contained as a copolymer component provided that they produce no adverse effect on antistatic and antifouling properties of the product.

As the polymerization method, known radical polymerization methods such as bulk polymerization, solution polymerization and emulsion polymerization can be used. The preferred polymerization method is solution polymerization in which the respective monomers are dissolved in a solvent, and after adding a polymerization initiator, the mixture is heated and stirred in a stream of nitrogen. As the solvent, water and alcohols such as methyl alcohol, ethyl alcohol and isopropyl alcohol are preferred, and these solvents may be used in admixture. As the polymerization initiator, peroxides such as benzoyl peroxide and lauroyl peroxide and azo compounds such as azobisbutyronitrile and azobisvaleronitrile are preferably used. The monomer concentration is usually 10 to 60% by weight, and the polymerization initiator is usually 0.1 to 10% by weight based on the monomers.

The molecular weight of the cationic copolymer can be set at any level according to the polymerization conditions such as polymerization temperature, type and amount of the polymerization initiator used, amount of the solvent used and chain transfer, type of the organopolysiloxane precursor used, content of the reactive groups, etc. Generally, the molecular weight of the obtained cationic copolymer is preferably in the range of 5,000 to 500,000. The coating layer formed on the biaxially oriented polyester film by using the coating material prepared in the manner described above is excellent in anti-stick quality, etc.

Other cationic copolymers usable in the present invention are, for instance, those comprising as main components a polymer having organopolysiloxane units and quaternary ammonium salt units, and an active energy ray-curing resin containing a polyfunctional acrylate having three or more acryloyl groups in the molecule.

The polymers having organopolysiloxane units and quaternary ammonium salt units may be ones having (meth)acryloyl groups in the side chain as required. These polymers having organopolysiloxane units and quaternary ammonium salt units can be obtained by polymerizing an organopolysiloxane compound having one radical polymerizable group in a molecule or two mercapto groups in a molecule and a tertiary amine compound having one radical polymerizable F group in a molecule, and converting the obtained tertiary amine polymeric compound to a quaternary ammonium salt with a quaternarizing agent.

When copolymerizing an organopolysiloxane compound and a tertiary amine compound having one radical group in a molecule, other (meth)acrylic esters may be copolymerized in addition to these monomers. The polymers having organopolysiloxane units and quaternary ammonium salt units can be also obtained by polymerizing an organopolysiloxane compound having one radical polymerizable group in a molecule or two mercapto groups in a molecule and a quaternary ammonium salt having one radical polymerizable group in a molecule. When copolymerizing an organopolysiloxane compound and a quaternary ammonium salt having one radical polymerizable group in a molecule, other (meth)acrylic esters may be copolymerized in addition to these monomers.

The organopolysiloxane compounds having one radical polymerizable group in a molecule are not specifically defined as far as they have one radical polymerizable group such as acryl, methacryl, styryl, cinnamic ester, vinyl and ally in a molecule, but in view of the ease of copolymerization of an organopolysiloxane compound having one radical polymerizable group in a molecule and a tertiray amine compound having a radical polymerizable group or quaternary ammonium salt having a radical polymerizable group, they are preferably those organopolysiloxane compounds which have an acrylic, methacrylic or styrylic radical polymerizable group.

Also, when polymerizing a tertiary amine compound having a radical polymerizable group or a quaternary ammonium salt having a radical polymerizable group, the organopolysiloxane compounds having two mercapto groups in a molecule which have been introduced into the polymer through sulfide linkage by chain transfer can be preferably used. The orgaonopolysiloxane units contained in these organopolysiloxane compounds are represented by the following formula (f): 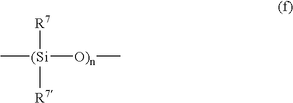
wherein R⁷ and R^{7′} represent independently a methyl or phenyl group, and n is an integer of 5 or more.

The number-average molecular weight of the organopolysiloxane compounds having one radical polymerizable group in a molecule is usually 400 to 60,000, preferably 1,000 to 30,000.

The tertiary amine compounds having one radical polymerizable group in a molecule are represented by the following formula (g): 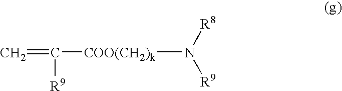
wherein R⁹ represents H or CH₃, R⁸ and R^{8′} represent independently H or a C₁-C₉ alkyl group which may contain a substituent group, and k is an integer of 1 to 6.

As such tertiary amine compounds having a radical polymerizable group, for example, N,N-dimethylaminoethyl(meth)acrylate, N,N-diethylaminoethyl(meth)acrylate, N,N-dimethylaminopropyl methacrylate, N,N-dimethylaminobutyl methacrylate, N,N-dihydroxyethylaminoethyl methacrylate, N,N-dipropylaminoethyl methacrylate, and N,N-dibutylaminoethyl methacrylate can be mentioned.

As the quaternary ammonium salts having one radical polymerizable group in a molecule, for example, those obtained by quaternarizing tertiary amine compounds represented by the above-shown formula (d) with a quaternarizing agent, for example, alkyl chlorides such as methyl chloride and butyl chloride, halides such as methyl bromide, methylbenzyl chloride and benzyl chloride, alkyl sulfates such as dimethyl sulfate, diethyl sulfate and dipropyl sulfate, and sulfonic esters such as methyl p-toluenesulfonate and methyl benzenesulfonate can be mentioned.

In the copolymerization of an organopolysiloxane compound having one radical polymerizable group or two mercapto groups in a molecule and a tertiary amine compound or quaternary ammonium salt having one radical polymerizable group in a molecule, it is possible to use (meth)acrylic esters in addition to the said monomers.

As such (meth)acrylic esters, for example, methyl(meth)acrylate, ethyl(meth)acrylate, n-butyl(meth)acrylate, isobutyl(meth)acrylate, 2-ethylhexyl(meth)acrylate, benzyl(meth)acrylate, cyclohexyl(meth)acrylate, isobonyl(meth)acrylate, dicyclopentenyl(meth)acrylate, dicyclopentenyloxyethyl(meth)acrylate, ethoxyethyl(meth)acrylate, ethylcarbitol(meth)acrylate, butoxyethyl(meth)acrylate, cyanoethyl(meth)acrylate, glycidyl(meth)acrylate, 2-hydroxyethyl(meth)acrylate and 2-hydroxypropyl(meth)acrylate, which have one radical polymerizable group in a molecule, can be mentioned.

In the copolymerization of an organopolysiloxane compound having one radical polymerizable group or two mercapto groups in a molecule and a tertiary amine compound or quaternary ammonium salt having one radical polymerizable group in a molecule, the amount of the organopolysiloxane compound having one radical polymerizable group or two mercapto groups in a molecule, which is used for the copolymerization, is usually 1 to 40% by weight, preferably 5 to 30% by weight, in 100% by weight of the copolymerizable monomeric mixture. If this amount is less than 1% by weight, it may prove unable to sufficiently bleed out the vinyl polymer to the coating layer surface, and the desired antistatic properties may not be afforded to the coating layer. If the said amount exceeds 40% by weight, no satisfactory antistatic properties may be obtained because of the drop of the ratio of the tertiary amine compound or quaternary ammonium salt having one radical polymerizable group in a molecule.

On the other hand, the amount of the tertiary amine compound or quaternary ammonium salt having one radical polymerizable group in a molecule is usually 60 to 99% by weight, preferably 60 to 95% by weight in 100% by weight of the copolymerizable monomers. If this amount is less than 60% by weight, satisfactory antistatic properties may not be provided to the coating layer. If the said amount exceeds 99% by weight, there may also not be provided desired antistatic properties to the coating layer because of the drop of the ratio of the organopolysiloxane compound.

The copolymerization of the said monomers, viz. an organopolysiloxane compound, a tertiary amine compound having a radical polymerizable group, a (meth)acrylic ester and a quaternary ammonium salt having a radical polymerizable group is usually carried out in a solvent using a radical polymerization initiator. As the solvent, there can be mentioned alcohols such as methyl alcohol, ethyl alcohol, n-propyl alcohol, iso-propyl alcohol and n-butyl alcohol, ketones such as acetone, methylethyl ketone, methylisobutyl ketone and cyclohexanone, esters such as ethyl acetate, propyl acetate and butyl acetate, aromatic hydrocarbons such as toluene and xylene, ethers such as 2-methoxyethanol, 2-ethoxyethanol, 2-butoxyethanol, ethylene glycol dimethyl ether, ethylene glycol diethyl ether and diethylene glycol dimethyl ether, ether-esters such as 2-methoxyethyl acetate, 2-ethoxyethyl acetate and 2-butoxyethyl acetate, and water. These solvents may be used in admixture.

As the radical polymerization initiator used for the polymerization reaction, organic peroxides such as benzoyl peroxide, di-t-butyl peroxide and cumene hydroperoxide, and azo compounds such as 2,2′-azobisisobutyronitrile, 2,2′-azobis(2,4-dimethylvaleronitrile) and 2,2′-azobis(4-methoxy-2,4-dimethylvaleronitrile) are used favorably. The monomer concentration in the polymer solution is usually 10 to 60% by weight, and the polymerization initiator is used in an amount of usually 0.1 to 10% by weight, preferably 0.3 to 5% by weight based on the monomeric mixture.

In case of copolymerizing an organopolysiloxane compound, a tertiary amine compound having one radical polymerizable group in a molecule and, if necessary, a (meth)acrylic ester, the tertiary amine polymer compound obtained from the copolymerization is converted to a quaternary ammonium salt by using a quaternarizing agent. As the quaternarizing agent, for example, alkyl chlorides such as methyl chloride and butyl chloride, halides such as methyl bromide, methylbenzyl chloride and benzyl chloride, alkyl sulfates such as dimethyl sulfate, diethyl sulfate and dipropyl sulfate, and sulfonic esters such as methyl p-toluenesulfonate and methyl benzenesulfonate can be mentioned.

Among the polymers having organopolysiloxane units and quaternary ammonium salt units obtained by these methods, those prepared by converting the tertiary amine polymer compound obtained by copolymerizing an orpanopolysiloxane compound having one radical polymerizable group or two mercapto groups in a molecule, a tertiary amine compound having one radical polymerizable group in a molecule and, if necessary, an (meth)acrylic ester, to a quaternary ammonium salt with an alkyl chloride, are especially preferred brcause they have excellent compatibility with the polyfunctional acrylates having three or more acryloyl groups in the molecule, and are also capable of providing a coating layer with good transparency.

When a polymer having organopolysiloxane units having (meth)acryloyl groups in the side chain and quaternary ammonium salt units is used as the polymer having organopolysiloxane units and quaternary ammonium salt units, linkage is formed between this polymer and the polyfunctional acrylate upon irradiation with the active energy rays to provide an improvement of durability of antistatic performance.

Among the polymers having organopolysiloxane units and quaternary ammonium salt units, those having (meth)acryloyl groups in the side chain can be obtained, for instance, by additionally copolymerizing glycidyl (meth)acrylate when copolymerizing an organopolysiloxane compound and a tertiary amine compound or quaternary ammonium salt having one radical polymerizable group in a molecule, and then adding a (meth)acrylic acid (in case of using a tertiary amine compound, the obtained tertiary amine polymer compound is further converted to a quaternary ammonium salt with a quaternarizing agent).

These polymers can be also obtained by adding an 1:1 (by mole) adduct of a (meth)acrylate having hydroxyl groups such as hydroxyethyl (meth)acrylate and hydroxypropyl (meth)acrylate and an isocyanate compound such as tolylene diisocyanate, isophorone diisocyante and hexamethylene diisocyanate after additionally copolymerizing a (meth)acrylate having hydroxyl groups such as hydroxyethyl (meth)acrylate, hydroxypropyl (meth)acrylate, pentaerythritol triacrylate or dipentaerythritol pentaacrylate when copolymerizing an organopolysiloxane compound and a tertiary amine compound or quaternary ammonium salt having one radical polymerizable group in a molecule (in case of using a tertiary amine compound, the obtained tertiary amine polymer compound is further converted to a quaternary ammonium salt with a quaternarizing agent).

Among the polymers having organopolysiloxane units and quaternary ammonium salt units and having (meth)acryloyl groups in the side chain obtained by these methods, those obtained by copolymerizing an organopolysiloxane compound having one radical polymerizable group or two mercapto groups in a molecule, a tertiary amine compound having one radical polymerizable group in a molecule and a (meth)acrylic ester having functional groups, then adding to the resulting polymer a compound having (meth)acryloyl groups, and converting the tertiary amine compound to a quaternary ammonium salt with an alkyl chloride are especially preferred as they show excellent compatibility with the polyfunctional acrylates having three or more acryloyl groups in the molecule and are also capable of provide a coating layer with good transparency.

As the polyfunctional acrylates having three or more acryloyl groups in the molecule, for example, trimethylolpropane triacrylate, ethylene oxide-modified trimethylolpropane triacrylate, propylene oxide-modified trimethylolpropane triacrylate, tris(acryloxyethyl)isocyanurate, caprolactone-modified tris(acryloxyethyl)isocyanurate, pentaerythritol triacrylate, pentaerythritol tetraacrylate, dipentaerythritol tetraacrylate, dipentaerythritol pentaacrylate, dipentaerythritol hexacrylate, alkyl-modified dipentaerythritol triacrylate, alkyl-modified dipentaerythritol tetraacrylate, alkyl-modified dipentaerythritol pentaacrylate, captrolactone-modified dipentaerythritol hexaacrylate, carboxyl group-containing polyfunctional acrylates obtained by reacting tetracarboxylic acid dianhydrides and hydroxyl group-containing polyfunctional acrylates having a hydroxyl group and three or more acryloyl groups in the molecule, and mixtures of two or more of these acrylates can be mentioned.

As the concrete examples of the tetracarboxylic acid dianhydrides, pyromellitic acid dianhydride, 3,3′,4,4′-benzophenonetetracarboxylic acid dianhydride, 4,4′-biphthalic acid anhydride, 4,4′-oxodiphthalic acid anhydride, 4,4′-(hexafluoroisopropylidene)diphthalic acid anhydride, 1,2,3,4-cyclopentatetracarboxylic acid dianhydride, 5-(2,5-dioxotetrahydrofur)-3-methyl-3-cyclohexene-1,2-dicarboxylic acid anhydride, 4-(2,5-dioxotetrahydrofuran-3-il)-tetralin-1,2-dicarboxylic acid anhydride, 3,4,9,10-perillenetetracarboxylic acid dianhydride, and bicyclo[2.2.2]octo-7-en-2,3,5,6-tetracarboxylic acid dianhydride can be mentioned.

As the concrete examples of the hydroxyl group-containing polyfunctional acrylates having a hydroxyl group and three or more acryloyl groups in the molecule, pentaerythritol triacrylate, dipentaerythritol tetraacrylate, dipentaerythritol pentaacrylate and mixtures thereof can be mentioned. Among these polyfunctional acrylates having three or more acryloyl groups in the molecule, dipentaerythritol hexaacrylate, dipentaerythritol pentaacrylate, carboxyl group-containing polyfunctional acrylates obtained by reacting tetracarboxylic acid dianhydrides and hydroxyl group-containing polyfunctional acrylates having a hydroxyl group and three or more acryloyl groups in the molecule, and mixtures thereof are especially preferred as they can provide a coating layer with excellent abrasion resistance.

In addition to the polymers having organopolysiloxane units and quaternary ammonium salt units and the polyfunctional acrylates having three or more acryloyl groups in the molecule, it is possible to use other polymeric monomers such as arylates having one or two acryloyl groups in the molecule. Specifically, it is possible to use urethane acrylates or epoxy acrylates having two acryloyl groups within limits not deteriorating abrasion resistance and antistatic properties (for example, not more than 20% by weight in the components of coating layer).

In case of using ultraviolet rays as the active energy rays for curing of the coating composition, a photopolymerization initiator is used in addition to a polymer having organopolysiloxane units and quaternary ammonium salt units and a polyfunctional acrylate having three or more acryloyl groups in the molecule such as mentioned above.

As the photopolymerization initiator, for example, 2,2-ethoxyacetophenone, 1-hydroxycyclohexylphenyl ketone, dibenzoyl, benzoin, benzoinmethyl ether, benzoinethyl ether, benzoinisopropyl ether, p-chlorobenzophenone, p-methoxybenzophenone, Michler's ketone, acetophenone, 2-chlorothioxanetone, anthraquinone, phenyl disulfide, 2-methyl-[4-(methylthio)phenyl]-2-morpholinopropane-1-one, 2-hydroxy-2-methyl-1-phenyl-propane-1-one, and 2,4,6-trimethylbenzoyl-diphenyl-phsophine oxide can be mentioned. These photopolymerization initiators can be used alone or as a mixture of two or more.

As the photopolymerization initiator assistant, tertiary amines such as triethylamine, triethanolamine and 2-dimethylaminoethanol, alkylphosphines such as triphenylphosphine, and thioethers such as β-thiodiglycol can be mentioned.

As the modifying agents, coating properties improver, defoaming agent, thickener, inorganic particles, organic particles, lubricant, organic polymers, dyes, pigment, stabilizing agent, etc., can be mentioned. These modifying agents are used within limits not impairing the reactions induced by the active energy rays and their use can improve the properties of the active energy ray-curing resin layer according to the purpose of use of the product film. In the composition of the active energy ray-curing resin layer, the solvent used in forming the copolymer may be blended for the adjustment of viscosity, improvement of coating workability and control of coating thickness.

In the active energy ray-curing coating composition of the present invention, various additives such as ultraviolet absorber (e.g. benzotriazole-based, benzophenone-based, salicylic acid-based and cyanoacrylate-based ultraviolet absorbers), ultraviolet stabilizer (e.g. hindered amine-based ultraviolet stabilizer), antioxidant (e.g. phenolic, sulfuric and phosphoric antioxidants), anti-blocking agent, slip agent and leveling agent may be blended for the purpose of improving the coating layer properties.

In the present invention, the content of the polymer having organopolysiloxane units and quaternary ammonium salt units in the active energy ray-curing coating composition is usually 1 to 40% by weight, preferably 5 to 25% by weight in 100% by weight of the solids. If this content is less than 1% by weight, there may not be obtained a coating layer having satisfactory antistatic properties. Also, if the content exceeds 40% by weight, abrasion resistance of the coating layer tend to lower.

In the present invention, the content of the polyfunctional acrylate having three or more acryloyl groups in the active energy ray-curing coating composition is usually 60 to 99% by weight, preferably 75 to 95% by weight in 100% by weight of the solids. If this content is less than 60% by weight, there may not be obtained a coating layer having satisfactory abrasion resistance, and if that content exceeds 99% by weight, a coating layer with satisfactory antistatic properties may not be obtained.

In the present invention, the solids concentration of the active energy ray-curing coating composition is not specifically defined, but it is usually adjusted to be 0.5 to 20% by weight, preferably 1 to 10% by weight, more preferably 1 to 5% by weight.

In the present invention, the content of the photopolymerization initiator in the activation energy ray-curing coating composition is not specifically defined provided that it is sufficient to cause curing of the resin composition, but it is usually 0.5 to 20% by weight, preferably 1 to 10% by weight, more preferably 1 to 5% by weight in 100% by weight of the solids.

In the present invention, formation of the coating layer is accomplished by a method in which the coating composition is applied on one side of the film and cured. As the coating method, reverse roll coating, gravure roll coating, rod coating, air knife coating, etc, can be used.

Curing of the applied coating composition is performed by the active energy rays or heat. As the active energy rays, ultraviolet rays, visible light rays, electron rays, x-rays, α-rays, β-rays, γ-rays, etc., can be used. As the heat source, infrared heater, heating oven, etc., can be used. Irradiation with the active energy rays is usually conducted from the coating layer side, but it may be conducted from the opposite side of the coating layer for enhancing adhesion to the film. If necessary, a reflector which is capable of reflecting the active energy rays may be utilized. The coating film cured by the active energy rays excels particularly in scratch resistance.

In the film of the present invention, it is essential that surface resistance of the coating layer is not more than 1×10¹¹ Ω. When surface resistance of the coating layer exceeds the above value, static electricity tends to be generated to encourage deposition of dust. Surface resistance of the coating layer is preferably not more than 5×10¹⁰ Ω, more preferably not more than 1×10¹⁰ Ω. In the present invention, the lower threshold value of surface resistance for retaining antistatic properties is 1×10⁷ Ω. If surface resistance is less than 1×10⁷ Ω, the surface shows conductivity, so that when the protective film is separated, the electrons which caused separation charging become conductive, which may result in breaking down circuits of the liquid crystal display board.

In the present invention, adhesive force (P2) of the acrylic adhesives to the coating layer surface is not more than 3,000 mN/cm, preferably not more than 2,750 mN/cm, more preferably not more than 2,500 mN/cm. The protective film base according to the present invention is stored in a stacked up state, so that in the step of cutting it to a desired size for storage, the adhesive layer which was accidentally squeezed out from between the polyester film and the release film may come into contact with the coating layer of another protective film. Such contact of the adhesive layer with the coating layer is undesirable as it becomes a cause of adhesion of the adhesive to the coating layer and its fouling when the adhesive force of the adhesive exceeds 3,000 mN/cm.

In the present invention, the difference (P1-P2) between adhesive force (P1) of rubber adhesives to the coating layer surface and adhesive force (P2) of acrylic adhesives is not less than 100 mN/cm, preferably not less than 200 mN/cm. If the difference in adhesive force is less than 100 mN/cm, separation of the protective film is difficult when it is tried to separate the film by using a rubber adhesive tape in the final step.

In the film of the present invention, film haze is not more than 2%, preferably not more than 1.5%. When film haze exceeds 2%, it becomes difficult to detect finer defects when the tests involving optical evaluations of display performance, hue, contract, contamination with foreign materials, etc., of the liquid crystal display board are conducted with the protective film left stuck on the board.

A preferred embodiment of the present invention is a laminated film comprising a biaxially oriented polyester film having a coating layer on one surface thereof and having laminated on the other side an adhesive layer and a release film for protecting it.

In the present invention, the adhesive layer comprises a known adhesive, for example, acrylic adhesive, rubber adhesive, block copolymeric adhesive, polyisobutylene adhesive and silicone adhesive. Generally, these adhesives are offered as a composition with an elastomer, tackifier, softener (plasticizer), deterioration preventive agent, filler, crosslinking agent, etc.

As the elastomer, for example, natural rubber, synthetic isoprene rubber, reclaimed rubber, SBR, block copolymer, polyisobutyrene, butyl rubber, polyacrylic ester copolymer and silicone rubber can be mentioned, of which appropriate one is selected according to the type of the adhesive to be applied.

As the tackifier, for example, rosin, hydrogenated rosin esters, terpene resin, aromatic modified terpene resin, hydrogenated terpene resin, terpene phenol resin, aliphatic petroleum resin, aromatic petroleum resin, alicyclic hydrogenated petroleum resin, cumarone-indene resin, styrene resin, alkyl phenol resin and xylene resin can be mentioned.

As the softener, for example, paraffinic process oil, naphthenic process oil, aromatic process oil, liquid polybutene, liquid polyisobutyrene, liquid polyisoprene, dioctyl phthalate, dibutyl phthalate, castor oil and tall oil can be mentioned.

As the deterioration preventive agent, for example, aromatic amine derivatives, phenol derivatives and organothio acid salts can be mentioned.

As the filler, for example, zinc white, titanium white, calcium carbonate, clay, pigment and carbon black can be mentioned. In case where a filler is contained, it is used within limits not greatly affecting the total light transmittance of the protective film.

As the crosslinking agent, for example, sulfur, a curing assistant and a curing accelerator (representative example: zinc dibutylthiocarbamate) are used for crosslinking of natural rubber adhesives. Polyisocyanates are used as the crosslinking agent which is capable of crosslinking the adhesives made of natural rubber and carboxylic acid copolymer polyisoprene at room temperature. Polyalkylphenol resins are used as a crosslinking agent having characteristically heat resistance and non-staining properties for crosslinking of butyl rubber and natural rubber. The organic peroxides such as benzoyl peroxide and dicumyl peroxide are available for crosslinking of the adhesives made of butadiene rubber, styrene rubber and natural rubber, and use of such organic peroxides provides non-staining adhesives. Polyfunctional methacrylic esters are used as crosslinking assistant. There are also known adhesives formed by other types of crosslinking such as ultraviolet crosslkinkg and electron ray crosslinking.

Formation of the adhesive layer, although not specifically defined, is conducted by a method in which an adhesive is applied on the other surface of the base film. As the coating method, the same method as used for forming the abrasion-resistant layer can be used. Thickness of the adhesive layer is usually in the range of 0.5 to 100 μm, preferably 1 to 50 μm.

In the present invention, the adhesive force of the adhesive layer is adjusted so that when an adhesive tape was pressed against the coating layer and pulled up, the adhesive layer will be separated away from the surface of the polarizing plate together with the biaxially oriented polyester film. In this case, the adhesive force between the polarizing plate and the adhesive layer is preferably adjusted to stay within the range of 10 to 400 mN/cm. On the surface of the adhesive layer is laminated a known release film for the convenience of handling. The polarizing plate referred to herein is of a structure in which a protective film such as triacetate cellulose film is laminated on both sides of a polarizing film made by containing iodine, dichromic dye, etc., in polyvinyl alcohol and monoaxially orienting the obtained film.

The total light transmittance (TL) of the polarizing plate protective film base of the present invention having the above-described structure is not specifically defined, but it is usually not less than 80%, preferably not less than 85%. Consequently, the tests involving optical evaluations of display performance, hue, contrast, contamination with foreign materials, etc., of the liquid crystal display board can be carried out with the protective film kept stuck on the surface of the polarizing plate.

### BEST MODE FOR CARRYING OUT THE INVENTION

Hereinafter, the present invention is described in further detail with reference to the examples thereof, but the present invention is not limited to these examples but can be embodied in other forms as well without departing from the scope of the invention. In the following Examples and Comparative Examples, all “parts” are by weight unless otherwise noted. Also, the determination methods and evaluation standards used in the present invention are as explained below.

(1) Surface Resistance (9) of the Coating Layer

Using “Hiresta-UP MCP-HT 450” mfd. by Dia Instruments Co., Ltd., the specimen was set in an atmosphere of 23° C. and 50% RH, an electric voltage of 500 V was applied thereto, and surface resistance (Ω) after one-minute charging (voltage application time: 1 min.) was measured. The electrode type used here was a concentric circular electrode assembly with the outer diameter of the main electrode being 50 mm and the inner diameter of the opposite electrode being 53.2 mm.

(2) Peel Force (P2) of the Coating Layer Against Acrylic Adhesive

A double-sided adhesive tape (“No. 502” mfd. by Nitto Denko Corporation was affixed on the coating layer and press bonded thereto by a rubber roller under a linear pressure of 450 g/cm, and the laminate was cut into a 50 mm wide piece to prepare a specimen for measuring peel force. After allowed to stand for one hour after press bonding, the tape was peeled at a pulling rate of 300 mm/min in the direction of 180 degrees by using an Instron tensile tester, and the mean value of the stress produced thereby was expressed as peel force of the specimen. This test was repeated 10 times, and the arithmetic mean of 10 measurements was presented here as peel force. The atmosphere under which this test was conducted was a standard state of 23° C. and 50% RH. (3) Peel force (P2) of the coating layer by rubber adhesives

Cellotape (registered trade name) made by Nichiban Co., Ltd. was affixed on the coating layer and press bonded by a rubber roller under a linear pressure of 450 g/cm to prepare a specimen for measuring peel force. After allowed to stand for one hour after press bonding, the tape was peeled at a pulling rate of 300 mm/min in the direction of 180 degrees by using an Instron tensile tester, and the mean value of the stress produced thereby was expressed as peel force of the specimen. This test was repeated 10 times and the arithmetic mean of 10 measurements was presented here as peel force. The atmosphere under which this test was conducted was a standard state of 23° C. and 50% RH.

(4) Presence or Absence of Adhesion of Dusts

Cigarette ash was dropped onto the surface of the coating layer, and after letting it make a turn (360-degree turn), the condition of adhesion of ash was observed, thereby assessing the presence or absence of adhesion of dusts.

(5) Presence or Absence of Adhesion of the Adhesive

An acrylic adhesive was rubbed on the surface of the coating layer, and the presence or absence of adhesion of the adhesive on the layer surface when it was tried to rub off the adhesive with fingers was assessed.

(6) Coating Layer Thickness

A small piece of coated film was stationary-molded with an epoxy resin and cut by a microtome, and a section of the film was observed through a transmission electron microscope. In that section, the coating layer can be observed by light and darkness substantially parallel to the film surface. The distance of the coating layer was averaged for each transmission electron microphotograph to calculate thickness. This operation was conducted on at least 50 copies of photograph. 10 measurements from both largest and smallest measurements of thickness were crossed out, and the arithmetic mean of the remaining 30 measurements was presented as thickness of the coating layer.

(7) Total Light Transmittance

Total light transmittance of the laminated film having a coating layer provided on one surface of a biaxially oriented polyester film was measured by an integrating sphere type turbidimeter NDH-300A mfd. by Nippon Denshoku Industries CO., Ltd.

(8) Haze

Haze of the laminated film having a coating layer provided on one surface of a biaxially oriented polyester film was measured by an integrating sphere type turbidimeter NDH-300A mfd. by Nippon Denshoku Industries Co., Ltd.

(9) Clarity

Sample films were placed 2 mm apart from each other on the Gradation Color Scale [1] in the Laser Dot Color Chart made by GE Kikaku Center Inc. and clarity was judged visually and ranked as follows.
A: Visible as clearly as the original throughout.
B. Hard to see up to the position of 5% half-tone dot density.
C: Hard to see up to the position of 10% half-tone dot density.
D: Hard to see up to the position of 20% half-tone dot density.

In the above ranking, A and B are of the levels that present no practical problem.

### PRODUCTION EXAMPLE 1 (POLYESTER A)

100 parts of dimethyl terephthalate, 60 parts of ethylene glycol and 0.09 parts of magnesium acetate tetrahydrate were supplied into a reactor. The mixture was heated to distill away methanol and carry out an ester exchange reaction, the temperature being raised to 230° C. taking 4 hours after start of the reaction to substantially complete the ester exchange reaction. Then an ethylene glycol slurry containing 0.03 parts of silica particles having an average size of 1.54 μm was added to the reaction system, after which 0.04 parts of ethyl acid phosphate and 0.01 part of germanium oxide were further added, with the temperature being raised to reach 280° C. while the pressure lowered to reach 15 mmHg in 100 minutes. The pressure was kept on reducing gradually to finally reach 0.3 mmHg. 4 hours thereafter, the system was returned to normal pressure, obtaining polyester A. The content of silica particles in polyester A was 0.03% by weight.

### PRODUCTION EXAMPLE 2 (POLYESTER B)

The same procedure as defined in Production Example 1 was conducted except that while an ethylene glycol slurry containing 0.03 parts of silica particles having an average size of 1.54 μm was added to the reaction system in Production Example 1, an ethylene glycol slurry containing 0.1 part of silica particles having an average size of 1.54 μm was added to the reaction system in this example to obtain polyester B. The content of silica particles in polyester B was 0.1% by weight.

### PRODUCTION EXAMPLE 3 (POLYESTER FILM A1)

Polyester A was dried in an inert gas atmosphere at 180° C. for 4 hours, then melt extruded by a melt extruder at 290° C. and cooled and solidified on a cooling roll set at a surface temperature of 40° C. by using the electrostatic pinning method to obtain a non-stretched sheet. The obtained sheet was stretched 3.5 times in the machine direction at 85° C., then stretched 3.7 times transversely at 100° C. and further heat set at 230° C. to obtain polyester film A1 with a thickness of 38 μm.

### PRODUCTION EXAMPLE 4 (POLYESTER FILM B)

The same procedure as defined in Production Example 3 was conducted except that polyester A was replaced by polyester B to obtain 38 μm thick polyester film B1.

### PRODUCTION EXAMPLE 5 (POLYESTER C)

The same procedure as defined in Production Example 1 was conducted except that while an ethylene glycol slurry containing 0.03 parts of silica particles having an average size of 1.54 μm was added to the reaction system in Production Example 1, an ethylene glycol slurry containing 1 part of titanium oxide particles having an average size of 0.27 μm was added to the reaction system in this example to obtain polyester C. The content of titanium oxide in polyester C was 1% by weight.

### PRODUCTION EXAMPLE 6 (POLYESTER FILM C1)

The same procedure as defined in Production Example 3 was conducted except that polyester A was replaced by polyester C to obtain 38 μm thick polyester film C1.

### EXAMPLE 1

55 parts of methyl methacrylate as hydrophobic monomeric unit, 50 parts of an 80% aqueous solution of methacryloxyethyltrimethylammonium chloride as cationic monomeric unit, 5 parts of one-end methacryloxy-modified organopolysiloxane having a molecular weight of approximately 5,000 (FM0721 produced by Chisso Corp.) as organopolysiloxane unit, 140 parts of ethyl alcohol and one part of azobisisobutyronitrile as polymerization initiator were added and the mixture was subjected to a 6-hour polymerization reaction at 80° C. in a stream of nitrogen to obtain a 40% ethyl alcohol solution of a cationic copolymer. This cationic copolymer was diluted with an ethyl alcohol/isopropyl alcohol (50/50) mixed solvent, and the solution was bar coated on one side of polyester film A1 so that the dry coating thickness would become 0.2 μm, and then dried to form a coating layer. An acrylic adhesive was applied on the side opposite from the coating layer of the polyester film and protected with a release film to obtain a laminated film.

### EXAMPLE 2

55 parts of methyl methacrylate as hydrophobic monomeric unit, 40 parts of an 80% aqueous solution of methacryloxyethyltrimethylammonium chloride as cationic monomeric unit, 5 parts of a mercapto-modified organopolysiloxane having a molecular weight of approximately 7,000 (X-22-980 produced by Shin-Etsu Chemical Co., Ltd.) as organopolysiloxane unit, 150 parts of isopropyl alcohol and one part of azobisisobutyronitrile as polymerization initiator were added, and the mixture was subjected to a 5-hour polymerization reaction at 80° C. in a stream of nitrogen to obtain a 40% isopropyl alcohol solution of a cationic copolymer. This cationic copolymer was diluted with isopropyl alcohol and the solution was coated on one side of polyester film A1 so that the dry coating thickness would become 0.15 μm, and then dried to form a coating layer. An acrylic adhesive was applied on the side opposite from the coating layer and protected with a release film to obtain a laminated film.

### EXAMPLE 3

51 parts of methyl methacrylate as hydrophobic monomeric unit, 50 parts of an 80% aqueous solution of methacryloxyethyltrimethylammonium chloride as cationic monomeric unit, 4 parts of methacrylic acid, 140 parts of ethyl alcohol and one part of azobisisobutyronitrile as polymerization initiator were added, and the mixture was subjected to a 6-hour polymerization reaction at 80° C. in a stream of nitrogen. Then 5 parts of a both-end epoxy-modified organopolysiloxane having a molecular weight of approximately 1,000 (FM5511 produced by Chisso Corporation) was added as organopolysiloxane unit and the mixture was reacted at 80° C. for 10 hours to obtain a 40% ethyl alcohol solution of a cationic copolymer. This cationic copolymer was diluted with ethyl alcohol and the solution was bar coated on one side of polyester film A1 so that the dry coating thickness would become 0.2 μm, and then dried to form a coating layer. An acrylic adhesive was applied on the side opposite from the coating layer and protected with a release film to obtain a laminated film.

### EXAMPLE 4

A mixture comprising 30 parts of an organopolysiloxane compound having a styrene group at one terminal and a number-average molecular weight of 11,300 (X-22-2440 produced by Shin-Etsu Chemical Industries Co., Ltd.), 70 parts of N,N-dimethylaminoethyl methacrylate and 150 parts of isopropyl alcohol was heated, and when the temperature reached 80° C. and 2 hours thereafter, respectively, 0.3 parts of azobisisobutyronitrile was added and the mixture was further reacted at 80° C. for 8 hours to obtain a copolymer solution with 40% solids. Next, 83.3 parts of isopropyl alcohol was added to the obtained copolymer solution, and then methyl chloride was introduced to the reaction system, allowing the mixture to react at 50° C. for 6 hours to obtain a polymer solution (4A) having organopolysiloxane units and quaternary ammonium salt units with a solids concentration of 34%.

Then, 163 parts of a mixture of 67 mol % of dipentaerythritol pentaacrylate and dipentaerythritol hexaacrylate (Kayarad DPHA produced by Nippon Kayaku Co., Ltd.), 21.8 parts of pyromellitic acid dianhydride, 100 parts of methyl ethyl ketone, 0.1 part of hydroquinone monomethyl ether and one part of N,N-dimethylbenzylamine were added and reacted at 80° C. for 8 hours to obtain a carboxyl group-containing polyfunctional acrylate solution (4B) with a solids concentration of 65%.

17 parts of (4A) obtained above, 83 parts of (4B), 3 parts of Ilgacure 907 (produced by Ciba Speciality Chemicals Co., Ltd.) as photopolymerization initiator and 897 parts of isopropyl alcohol were mixed uniformly to prepare an active energy ray-curing coating composition. Then, this composition was coated on one surface of polyester film A1 so that the coating thickness after curing would become 0.15 μm, and the coating was irradiated by a 120 W/cm energy high pressure mercury arc lamp from a distance of 100 mm for 15 seconds to form a coating layer. An acrylic adhesive was applied on the side opposite from the coating layer of the film A1 and protected with a release film to obtain a laminated film.

### EXAMPLE 5

A mixture comprising 10 parts of an organopolysiloxane compound having mercapto groups at both terminals and a number-average molecular weight of approximately 3,340 (X-22-167B produced by Shin-Etsu Chemical Co., Ltd.), 80 parts of N,N-dimethylaminoethyl methacrylate, 10 parts of methyl methacrylate and 150 parts of isopropyl alcohol was heated, and when the temperature reached 80° C. and 2 hours thereafter, respectively, 0.3 parts of azobisisobutyronitrile was added, and the mixture was reacted at 80° C. for 8 hours to obtain a copolymer solution with 40% solids. Next, 83.3 parts of isopropyl alcohol was added to the obtained copolymer solution, and then methyl chloride was introduced to the reaction system, allowing the mixture to react at 50° C. for 6 hours to obtain a 35% solids concentration polymer solution (5A) having organopolysiloxane units and quaternary ammonium salt units.

17 parts of (5A) obtained above, 53 parts of dipentaerythritol hexaacrylate, 3 parts of Ilgacure 907 (produced by Ciba Speciality Chemicals Co., Ltd.) as photopolymerization initiator and 927 parts of isopropyl alcohol were mixed uniformly to prepare an active energy ray-curing coating composition. Then, this composition was coated on one surface of polyester film A1 so that the coating thickness after curing would become 0.15 μm, and irradiated by a 120 W/cm energy high pressure mercury arc lamp from a distance of 100 mm for 15 seconds to form a coating layer. An acrylic adhesive was applied on the side opposite from the coating layer of the film A1 and protected with a release film to obtain a laminated film.

### EXAMPLE 6

A mixture comprising 15 parts of an organopolysiloxane compound having a methacryloyl group at one terminal and a number-average molecular weight of approximately 10,000 (FM0725 produced by Chisso Corp.), 75 parts of N,N-dimethylaminoethyl methacrylate, 10 parts of 2-hydroxyethyl methacrylate and 150 parts of methyl ethyl ketone was heated, and when the temperature reached 80° C. and 2 hours thereafter, respectively, 0.3 parts of azobisisobutyronitrile was added, and the mixture was reacted at 80° C. for 8 hours to obtain a copolymer solution with 40% solids. To this solution, 8 parts of methacryloyl isocyanate was added, and the mixture was reacted at 80° C. for 6 hours to obtain a copolymer solution with 42% solids having a methacryloyl group in the side chain. Next, 300 parts of isopropyl alcohol was added to the obtained copolymer solution, and then methyl chloride was introduced to the reaction system to carry out reaction at 50° C. for 6 hours to obtain a polymer solution (6A) with a 22% solids concentration having organopolysiloxane units and quaternary ammonium salt units and also containing methacryloyl groups.

26 parts of (6A) obtained above, 53 parts of dipentaerythritol hexaacrylate, 3 parts of Ilgacure 907 (produced by Ciba Speciality Chemicals Co., Ltd.) as photopolymerization initiator and 918 parts of isopropyl alcohol were mixed uniformly to prepare an active energy ray-curing coating composition. Then, this composition was coated on one surface of polyester film A1 so that coating thickness after curing would become 0.15 μm, and irradiated by a 120 W/cm energy high pressure mercury arc lamp from a distance of 100 mm for 15 seconds to form a coating layer. An acrylic adhesive was applied on the side opposite from the coating layer and protected with a release film to obtain a laminated film.

### EXAMPLE 7

A mixture comprising 10 parts of an organopolysiloxane compound having a styrene group at one terminal and a number-average molecular weight of 11,300 (X-22-2440 produced by Shin-Etsu Chemical Co., Ltd.), 80 parts of N,N-dimethylaminoethyl methacrylate, 10 parts of 2-hydroxyethyl methacrylate and 150 parts of methyl ethyl ketone was heated, and when the temperature reached 80° C. and 2 hours thereafter, respectively, 0.3 parts of azobisisobutyronitrile was added, allowing the mixture to react at 80° C. for 8 hours to obtain a copolymer solution with 40% solids. To this solution was added 50 parts of a compound obtained by reacting 28 parts of isophorone diisocyanate and 22 parts of 2-hydroxyethyl acrylate, and the mixture was reacted at 80° C. for 6 hours to obtain a copolymer solution with 50% solids having an acryloyl group in the side chain.

Next, 300 parts of isopropyl alcohol was added to the copolymer solution obtained here, and then methyl chloride was introduced to the reaction system to carry out reaction at 50° C. for 6 hours to obtain a polymer solution (7A) with 28% solids concentration having organopolysiloxane units and quaternary ammonium salt units and also having an acryloyl group in the side chain.

20 parts of (7A) obtained above, 53 parts of dipentaerythritol hexaacrylate, 6 parts of Darocure 1173 produced by Ciba Specialty Chemicals Co., Ltd., as photopolymerization initiator, and 921 parts of isopropyl alcohol were mixed uniformly to prepare an active energy ray-curing coating composition. Then, this composition was coated on one surface of polyester film A1 so that coating thickness after curing would become 0.15 μm, and irradiated by a 120 W/cm energy high pressure mercury arc lamp from a distance of 100 mm for 15 seconds to form a coating layer. An acrylic adhesive was applied on the side opposite from the coating layer and protected with a release film to obtain a laminated film.

### EXAMPLE 8

17 parts of the polymer solution (4A) obtained in Example 4, 53 parts of dipentaerythritol hexaacrylate, 6 parts of Ilgacure 184 (produced by Ciba Specialty Chemicals Co., Ltd.) as photopolymerization initiator, and 924 parts of isopropyl alcohol were mixed uniformly to prepare an active energy ray-curing coating composition. Then, this composition was coated on one surface of the polyester film Al so that coating thickness after curing would become 0.15 μm, and irradiated by a 120 W/cm energy high pressure mercury arc lamp from a distance of 100 mm for 15 seconds to form a coating layer. An acrylic adhesive was applied on the side opposite from the coating layer of the polyester film and protected with a release film to obtain a laminated film.

### COMPARATIVE EXAMPLE 1

Sodium p-styrenesulfonate (40 parts), sodium vinylsulfonate (40 parts) and N,N′-dimethylaminomethacrylate (20 parts) were dissolved in distilled water, to which 2,2′-azobis(2-aminodipropane)dihydrochloride was added as polymerization initiator with stirring under heating at 60° C to carry out polymerization, thereby obtaining an antistatic resin. Then, to 30 parts of this antistatic resin were blended 50 parts of a polyurethane resin (a polyester polyol comprising isophorone diisocyanate as isocyanate component, and terephthalic acid, isophthalic acid, ethylene glycol or diethylene glycol as polyol component; chain-lengthening agent: 2,2-dimethylolpropionic acid), 10 parts of an acrylic resin (comprising the following units: methyl methacrylate, N,N′-dimethylaminoethyl methacrylate, 2-hydroxyethyl methacrylate and butyl acrylate), 5 parts of a trifunctional water-soluble epoxy compound and 5 parts of colloidal silica having an average particle size of 0.1 μm to prepare a water-dispersed coating solution.

Then the same procedure as defined in Production Example 4 was conducted except that after stretching the sheet in the machine direction, the said water-dispersed coating solution was coated so that coating thickness after stretching and drying would become 0.1 μm to obtain polyester film B2. An acrylic adhesive was applied on the side opposite from the water-dispersed coating layer of the said polyester film B2 and protected with a release film to obtain a laminated film.

### COMPARATIVE EXAMPLE 2

60 parts of methyl methacrylate as hydrophobic monomeric unit, 50 parts of an 80% aqueous solution of methacryloxyethyltrimethylammonium chloride as cationic monomeric unit, 140 parts of ethyl alcohol and one part of azobisisobutyronitrile as polymerization initiator were added and subjected to a 6-hour polymerization reaction at 80° C. in a stream of nitrogen to obtain a 40% ethyl alcohol solution of a cationic copolymer. This cationic copolymer was diluted with an ethyl alcohol/isopropyl alcohol (50/50) mixed solvent, bar coated on one side of polyester film B1 so that dry coating thickness would become 0.2 μm, and dried to form a coating layer. An acrylic adhesive was applied on the side opposite from the coating layer and protected with a release film to obtain a laminated film.

### COMPARATIVE EXAMPLE 3

A mixture comprising 80 parts of N,N-dimethylaminoethyl methacrylate, 20 parts of methyl methacrylate and 150 parts of isopropyl alcohol was heated, and when the temperature reached 80° C. and 2 hours thereafter, respectively, 0.3 parts of azobisisobutyronitrile was added, and the mixture was reacted at 80° C. for 8 hours to obtain a copolymer solution with 40% solids. Next, 83.3 parts of isopropyl alcohol was added to the thus obtained copolymer solution, and then methyl chloride was introduced to the reaction system to carry out reaction at 500° C. for 6 hours to obtain a polymer solution (8A) having quaternary ammonium salt units with a solids concentration of 34%.

17 parts of (8A) obtained above, 53 parts of dipentaerythritol hexaacrylate, 3 parts of Ilgacure 907 (produced by Ciba Specialty Chemicals Co., Ltd.) as photopolymerization initiator and 927 parts of isopropyl alcohol were mixed uniformly to prepare an active energy ray-curing coating composition. Then, this composition was coated on one surface of polyester film B1 so that coating thickness after curing would become 0.15 μm, and irradiated by a 120 W/cm energy high pressure mercury arc lamp from a distance of 100 mm for 15 seconds to form a coating layer. An acrylic adhesive was applied on the side opposite from the coating layer and protected with a release film to obtain a laminated film.

### COMPARATIVE EXAMPLE 4

A laminated film was obtained in the same way as in Example 1 except that the dry coating thickness was altered to 0.1 μm.

### COMPARATIVE EXAMPLE 5

A laminated film was obtained in the same way as in Example 4 except that polyester film A1 was replaced by polyester film C1.

The properties of the thus obtained laminated films of Examples 1 to 8 and Comparative Examples 1 to 5 are shown in Tables 1 and 2 given below.

TABLE 1

| | Example 1 | Example 2 | Example 3 | Example 4 |
|---|---|---|---|---|
| Surface resistance | 3 × 10⁹ | 3 × 10⁹ | 1 × 10⁹ | 9 × 10⁸ |
| P2 (mN/cm) | 2100 | 2200 | 2100 | 2200 |
| P1 (mN/cm) | 2400 | 2500 | 2400 | 2500 |
| P1 − P2 (mN/cm) | 300 | 300 | 300 | 300 |
| Total light transmittance | 90 | 90 | 90 | 90 |
| Haze | 0.9 | 0.9 | 0.9 | 0.9 |
| Adhesion of dusts | None | None | None | None |
| Adhesion of adhesives | None | None | None | None |
| Clarity | A | A | A | A |
| | Example 5 | Example 6 | Example 7 | Example 8 |
| Surface resistance | 5 × 10⁸ | 7 × 10⁸ | 5 × 10⁸ | 4 × 10⁸ |
| P2 (mN/cm) | 2200 | 2200 | 2200 | 2200 |
| P1 (mN/cm) | 2500 | 2500 | 2500 | 2500 |
| P1 − P2 (mN/cm) | 300 | 300 | 300 | 300 |
| Total light transmittance | 90 | 90 | 90 | 90 |
| Haze | 0.9 | 0.9 | 0.9 | 0.9 |
| Adhesion of dusts | None | None | None | None |
| Adhesion of adhesives | None | None | None | None |
| Clarity | A | A | A | A |

TABLE 2

| | Comparative Example | | | | |
|---|---|---|---|---|---|
| | 1 | 2 | 3 | 4 | 5 |
| Surface | 6 × 10⁸ | 1 × 10⁹ | 3 × 10¹¹ | 1 × 10⁹ | 9 × 10⁸ |
| resistance | | | | | |
| P2 (mN/cm) | 4000 | 3100 | 2200 | 2260 | 2200 |
| P1 (mN/cm) | 4300 | 3400 | 2500 | 2290 | 2500 |
| P1 − P2 (mN/cm) | 300 | 300 | 300 | 300 | 300 |
| Total light | 88 | 89 | 90 | 90 | 75 |
| transmittance | | | | | |
| Haze | 3.7 | 3.4 | 0.9 | 1.0 | 15 |
| Adhesion of | None | None | Present | None | None |
| dusts | | | | | |
| Adhesion of | Present | Present | None | None | None |
| adhesives | | | | | |
| Clarity | A | A | A | A | A |

### INDUSTRIAL APPLICABILITY

The film of the present invention excels in transparency, antistatic properties, chemical resistance, scratch resistance, handling quality, etc., and consequently it can facilitate the tests of high-precision liquid crystal display boards, etc. It also has the characteristic properties such as being excellent in preventing adhesion or deposition of adhesives, dusts, etc., on the liquid crystal display boards. Further, when the film is separated and discarded as useless matter after performing the role of protecting the polarizing plate, such separation can be effected with ease, producing an effect of inhibiting separation charging, thus making it possible to provide a base for the polarizing plate protective films which is capable of preventing damage to the circuits connected to the liquid crystal display board due to such separation charging, so that the industrial value of the present invention is high.

1. A base for polarizing plate protective film, which base is stuck on the
surface of a polarizing plate of a liquid crystal display board, comprises a biaxially oriented polyester film having a coating layer on one surface thereof and has such properties that:
the surface resistance of said coating layer is not higher than 1×10¹¹ Ω,
the adhesive force (P2) of the acrylic adhesives to the coating layer surface is not more than 3,000 mN/cm,
the difference (P1-P2) between the adhesive force (P1) of the rubber adhesives to the coating layer surface and the adhesive force (P2) of the acrylic adhesives is not less than 100 mN/cm and
the film haze is not higher than 2%.

2. A base for polarizing plate protective film according to claim 1, wherein
the coating layer contains an antistatic agent.

3. A base for polarizing plate protective film according to claim 1, wherein the coating layer contains silicone compound.

4. A base for polarizing plate protective film according to claim 1 wherein thickness of the coating layer is 0.01 to 0.3 μm.

5. A base for polarizing plate protective film according to any one of claims 1 to 4, wherein the polyester film has an adhesive layer on the side opposite from the coating layer.

6. A base for polarizing plate protective film according to claim 5 wherein
the adhesive layer comprises at least one type of adhesive selected from the group consisting of acrylic adhesive, rubber adhesive, block copolymer adhesive, polyisobutyrene adhesive and silicone adhesive.

7. A base for polarizing plate protective film according to claim 5 wherein a release film is laminated on the adhesive layer surface.

8. A base for polarizing plate protective film according to claim 6 wherein a release film is laminated on the adhesive layer surface.

9. A base for polarizing plate protective film according to claim 2, wherein the coating layer contains silicone compound.

10. A base for polarizing plate protective film according to claim 2 wherein thickness of the coating layer is 0.01 to 0.3 μm.

11. A base for polarizing plate protective film according to claim 3 wherein thickness of the coating layer is 0.01 to 0.3 μm.

12. A base for polarizing plate protective film according to claim 9 wherein thickness of the coating layer is 0.01 to 0.3 μm.

13. A base for polarizing plate protective film according to any one of claims 9-12, wherein the polyester film has an adhesive layer on the side opposite from the coating layer.

14. A base for polarizing plate protective film according to claim 13 wherein
the adhesive layer comprises at least one type of adhesive selected from the group consisting of acrylic adhesive, rubber adhesive, block copolymer adhesive, polyisobutyrene adhesive and silicone adhesive.

15. A base for polarizing plate protective film according to claim 13 wherein a release film is laminated on the adhesive layer surface.

16. A base for polarizing plate protective film according to claim 14 wherein a release film is laminated on the adhesive layer surface.
